(19) United States
(12) Patent Application Publication
(10) Pub. No.: US 2026/0141663 A1
(43) Pub. Date: May 21, 2026

(54) Co-Presence Framework for Multiuser Extended Reality Environments

(71) Applicant: Meta Platforms Technologies, LLC, Menlo Park, CA (US)

(72) Inventors: Ryan WALTON, San Francisco, CA (US); Wayne CHEN SPIEGEL, San Francisco, CA (US); Fangwei LEE, San Carlos, CA (US); Philippe KIMURA-THOLLANDER, Seattle, WA (US); Jason Michael NELSON, Leander, TX (US); Daniel Peter MOLLER, London (GB); Pierre SEIGNEURBIEUX, Mountain View, CA (US); Bina THAKKAR, Cary, NC (US); Thomas KNOWLES, Zurich (CH); Laurent CHARBONNEL, Los Angeles, CA (US); Gabriel Benjamin Mark SHALOM, London (GB)

(21) Appl. No.: 19/446,049

(22) Filed: Jan. 12, 2026

Related U.S. Application Data
(60) Provisional application No. 63/754,912, filed on Feb. 6, 2025.
(60) Provisional application No. 63/763,074, filed on Feb. 25, 2025.
(60) Provisional application No. 63/768,785, filed on Mar. 7, 2025.
(60) Provisional application No. 63/821,653, filed on Jun. 11, 2025.

(51) Int. Cl. G06T 19/20; G06T 19/00

(52) U.S. Cl. CPC G06T 19/20; G06T 19/006; G06T 2219/024; G06T 2219/2004

(57) ABSTRACT

Aspects of the present disclosure are directed to establishing a shared anchor object and common coordinate system amongst multiple extended reality (XR) systems accessing a multiuser XR environment. Virtual objects (including avatars of users accessing the multiuser XR environment via respective XR systems) can be consistently mapped in the XR environment relative to the anchor object. The anchor object can be a virtual object, such as a menu or shape (e.g., a ring), or a physical object, such as a stage computing device positioned in the users' surrounding real-world environments. The users can move the anchor object as rendered on their respective XR systems, which can cause reciprocal movement of their corresponding avatars on other users' XR systems. The users can further move virtual objects relative to the anchor object, which can cause similar movement relative to the anchor object in the XR environment as rendered on the accessing XR systems. Thus, virtual objects can be consistently referenced across all of the XR systems accessing the XR environment.

### CROSS REFERENCE TO RELATED APPLICATIONS

This application claims priority to U.S. Patent Provisional Application No. 63/754,912, filed Feb. 6, 2025, titled “Virtual Object Extraction And Repository For Content Creation;” and to U.S. Patent Provisional Application No. 63/763,074, filed Feb. 25, 2025, titled “Level-Of-Detail-Based Three-Dimensional Model Generation;” and to U.S. Patent Provisional Application No. 63/768,785, filed Mar. 7, 2025, titled “Multi-User Remotely Generated Scene Background;” and to U.S. Patent Provisional Application No. 63/821,653, filed Jun. 11, 2025, titled “Co-Presence Framework for Multiuser Extended Reality Environments,” all of which are herein incorporated by reference in their entirety.

### BACKGROUND

Extended reality (XR) devices are becoming more prevalent. As they become more popular, the applications implemented on such devices are becoming more sophisticated. Mixed reality (MR) and augmented reality (AR) applications can provide interactive three-dimensional (3D) experiences that combine images of the real-world with virtual objects, while virtual reality (VR) applications can provide an entirely self-contained 3D computer environment. For example, an MR or AR application can be used to superimpose virtual objects over a real scene that is observed by a camera. A real-world user in the scene can then make gestures captured by the camera that can provide interactivity between the real-world user and the virtual objects. AR, MR, and VR (together XR) experiences can be observed by a user through a head-mounted display (HMD), such as glasses or a headset. An HMD can have a pass-through display, which allows light from the real-world to pass through a lens to combine with light from a waveguide that simultaneously emits light from a projector in the HMD, allowing the HMD to present virtual objects intermixed with real objects the user can actually see.

### BRIEF DESCRIPTION OF THE DRAWINGS

FIG. 1A is a conceptual diagram illustrating an example view on an extended reality (XR) system of a virtual anchor object that can be used to provide spatial consistency for multiple users in a shared XR environment.

FIGS. 1B and 1C are conceptual diagrams illustrating example views from an XR system of a user when the user moves toward an anchor object.

FIGS. 2A and 2B are conceptual diagrams illustrating example positionings of avatars around an anchor object.

FIG. 3 is a conceptual diagram of a shared XR environment in a theater configuration.

FIG. 4 is a flow diagram illustrating a process used in some implementations for providing a common coordinate system for a multiuser extended XR environment via an anchor object.

FIG. 5 is a block diagram illustrating an overview of devices on which some implementations of the present technology can operate.

FIG. 6 is a block diagram illustrating an overview of an environment in which some implementations of the present technology can operate.

### DETAILED DESCRIPTION

Aspects of the present disclosure relate to an anchor object to which virtual objects can be consistently mapped in an extended reality (XR) environment. In some implementations, the virtual objects can include avatars of users accessing the XR environment on respective XR systems. The anchor object can be a virtual object, such as a menu or shape (e.g., a ring), or a physical object, such as an inert physical device tracked by an XR system or a stage device (described further herein) positioned in the users' surrounding real-world environments. A user can move the anchor object, as rendered or shown on their XR system, which can cause the virtual objects surrounding the user to reposition to maintain their respective positions and poses relative to the anchor object. Such movement of the anchor object by the user can cause reciprocal movement of the user's corresponding avatar as rendered on other users' XR systems. In some implementations, movement of the anchor object is not rendered by the other users' XR systems. Thus, virtual objects can be consistently referenced across all of the XR systems accessing the XR environment.

For example, a first user can access an artificial reality (XR) birthday experience on a first XR device, in which virtual decorations and virtual gifts are overlaid on a view of a real-world home surrounding the first user. A virtual anchor object (e.g., an application menu) can be rendered in front of, and within arm's reach of, the first user. A second user can join the XR birthday experience on a respective second XR device to share in the celebration, and can be rendered as an avatar on the first user's XR device. The first user, sitting on the couch, may be unable to reach a virtual gift rendered on a physical table in front of the anchor object. Thus, the first user can reach forward, grab the anchor object, and bring it closer, e.g., by 0.5 meters and rotating it. Correspondingly, as rendered on the first user's XR device, the virtual gift (and other virtual decorations and objects) is moved toward the first user and by the same rotational amount. The first user can then grab the virtual gift, now within reach, and unwrap it.

Conversely, as rendered on the second user's XR device, the anchor object, in some cases, may not move. Instead, the first user's avatar is moved, from the perspective of the second user, relative to the anchor object by a corresponding amount (e.g., toward the anchor object 0.5 meters and rotationally). The first user's avatar is then rendered grabbing and unwrapping the virtual gift from this closer location. On the first user's XR device, the first user can then point to a virtual cake 90 degrees directly to the left, which has been moved forward 0.5 meters due to the movement of the anchor object. Although the anchor object has not been moved on the second user's XR device, the position of the first user's avatar has been moved forward 0.5 meters. Thus, on the second user's XR device, the first user's avatar is still seen pointing to the virtual cake 90 degrees directly to the left of the first user's avatar.

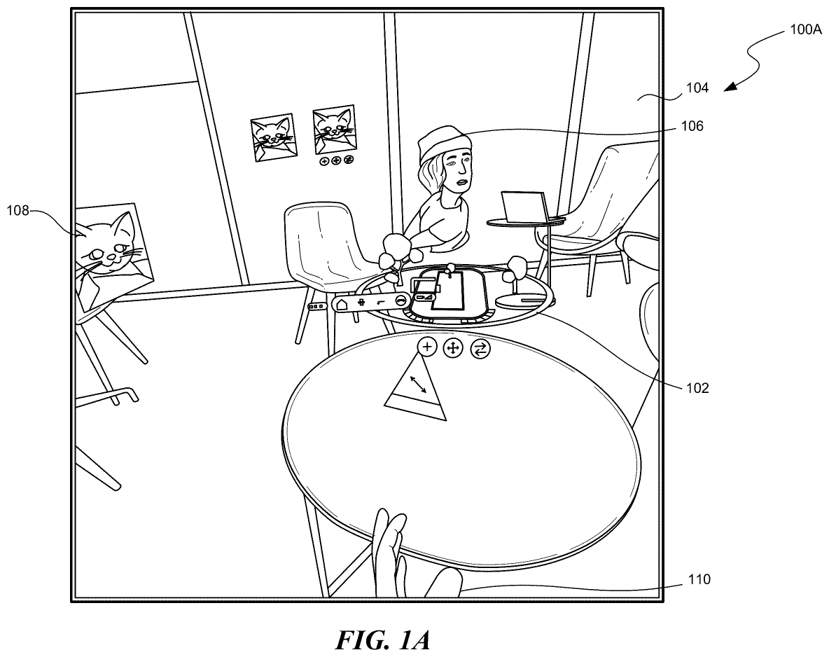

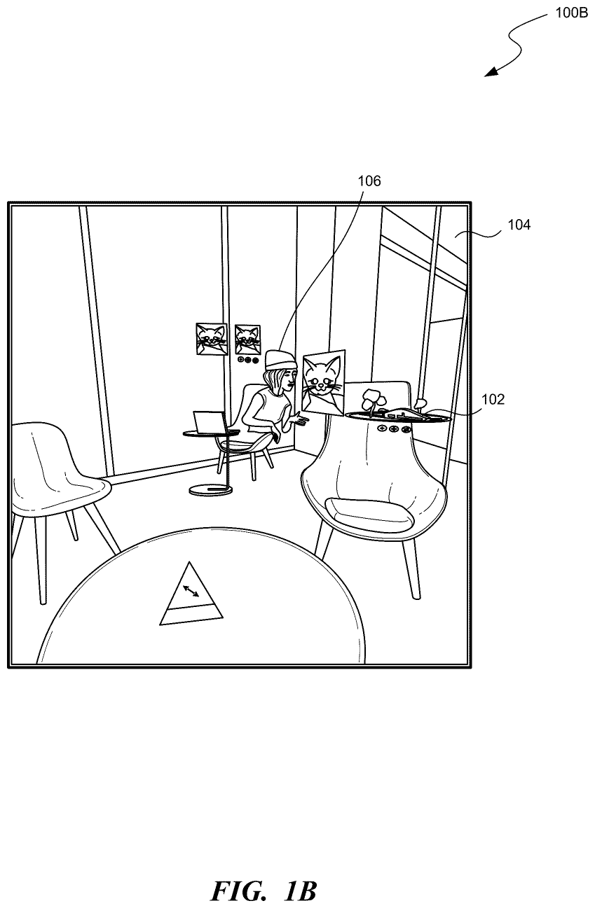

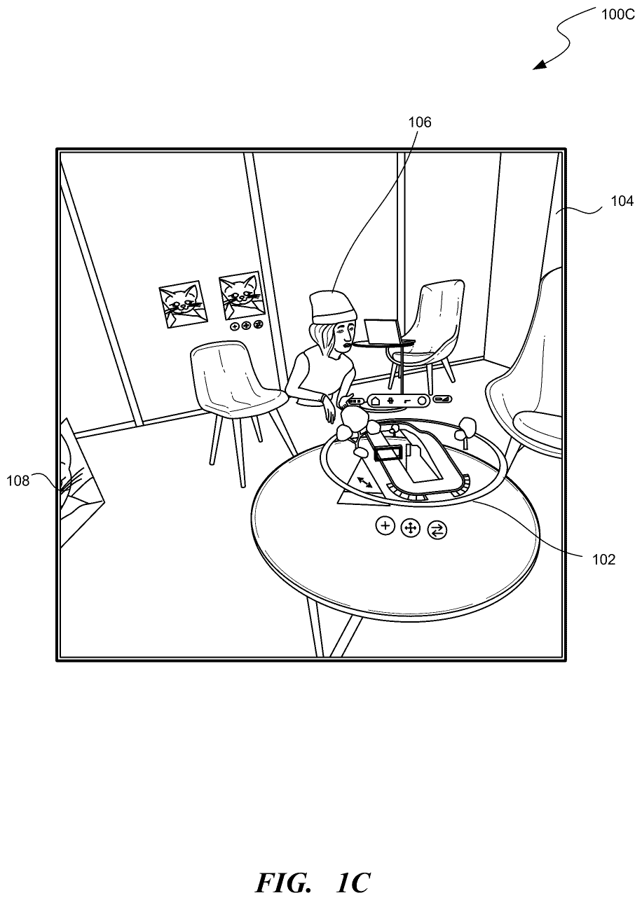

FIG. 1A is a conceptual diagram illustrating an example view 100A on an extended reality (XR) system of a virtual anchor object 102 that can be used to provide spatial consistency for multiple users in a shared XR environment 104. View 100A can be from the perspective of a user, on an XR system, having avatar 110. In this example, all avatars (e.g., avatar 106) and virtual objects (e.g., virtual object 108) can be fixed relative to virtual anchor object 102, and virtual anchor object 102 can be moveable and rotatable in XR environment 104. Thus, the user (having avatar 110) can select the location of virtual anchor object 102 in XR environment 104, and, correspondingly, the location of the avatars (e.g., avatar 106) and virtual objects (e.g., virtual object 108) in XR environment 104. In this view 100A, virtual anchor object 102 can be a white ring to which virtual objects both inside and outside are locked.

FIGS. 1B and 1C are conceptual diagrams illustrating example views 100B-C from an XR system of a user (represented by avatar 110 shown in view 100A of FIG. 1A) when the user's avatar 110 both moves toward and moves an anchor object 102. As avatar 110 moves toward anchor object 102, the other user accessing XR environment 104 (associated with avatar 106) will see avatar 110 approach anchor object 102. As avatar 110 moves clockwise around anchor object 102, the other user will correspondingly see the avatar 110 move clockwise around anchor object 102.

As the user moves anchor object 102 (e.g., by selecting and dragging anchor object 102), all XR content (including, e.g., avatar 106 and virtual object 108) will move with anchor object 102, such that the XR content maintains relative positions with anchor object 102, as rendered on the user's XR system, and as shown in view 100C of FIG. 1C. Assuming no movement or manipulation of anchor object 102 on the part of other users, the other users (e.g., the user associated with avatar 106) will see the shared XR content maintain their relative positions to anchor object 102, and anchor object 102 maintaining its location, but will see avatar 110 move relative to anchor object 102.

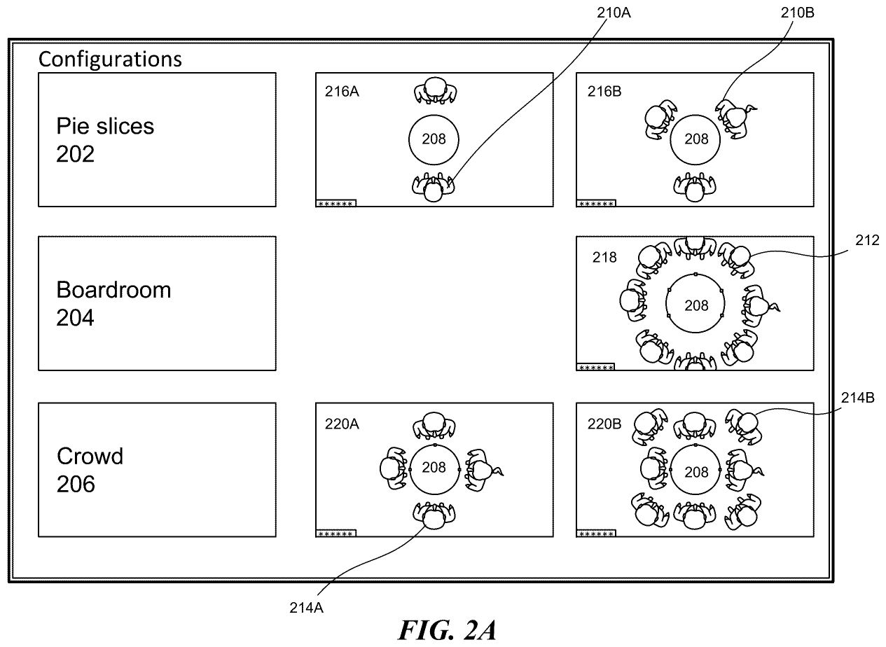

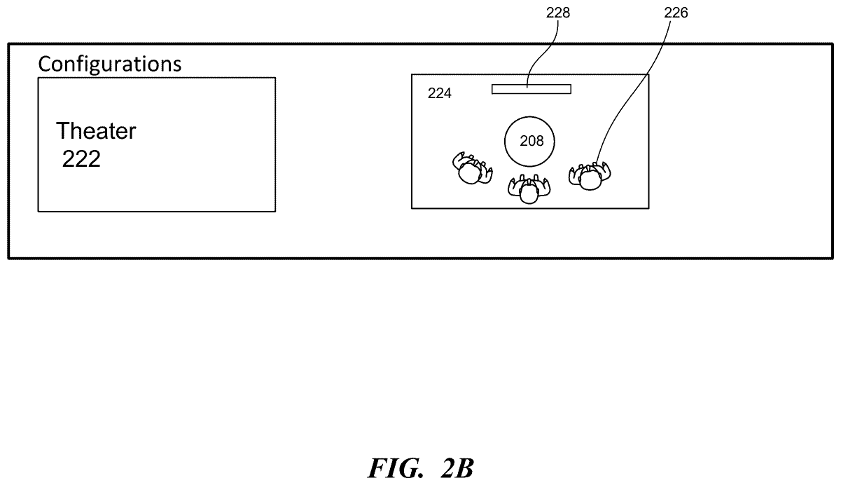

FIGS. 2A and 2B are a conceptual diagrams illustrating example positionings of avatars (e.g., 210A-210B, 212, 214A-214B) relative to an anchor object 208. XR content, such as avatars (e.g., 210A-210B, 212, 214A-214B, 226) and/or other virtual objects, can appear in different orientations relative to anchor object 208. For example, as shown in FIG. 2A, avatars 210A-210B, 212, 214A-214B can be positioned in a circle around anchor object 208. In another example, as shown in FIG. 2B, avatars 226 can be positioned in an arc relative to anchor object 208. In some implementations, avatars 210A-210B, 212, 214A-214B, 226 can be automatically positioned around anchor object 208 according to various configurations 202-206, 222. For example, the avatars can be positioned in a circle around anchor object 208 by default, unless a panel or virtual media screen is present in the XR environment, in which case the avatars can be positioned or repositioned into an arc configuration. In some implementations, when repositioning the avatars from a circle configuration to an arc configuration (or vice versa), the XR systems can show such movement from the perspective of the users' corresponding avatars, or can fade out from the perspective in one configuration and fade into the other to reduce motion sickness.

For example, in configuration 202, avatars can be positioned around anchor object 208 as if anchor object 208 were split into pie slices equally based on the number of users, such as shown in examples 216A-216B. In example 216A, for two avatars (including, e.g., avatar 210A), the avatars can appear directly across anchor object 208 from each other, as if anchor object 208 were split into two pie slices. In example 216B, for three avatars (including, e.g., avatar 210B), the avatars can appear at three equidistant points around anchor object 208, as if anchor object 208 were split into three pie slices.

In configuration 204, avatars (including, e.g., avatar 212) can all be positioned around anchor object 208, such that they appear at seats around anchor object 208 (which can be, for example, a virtual conference table), as shown in example 218. In some implementations, as the number of avatars around anchor object 208 grows, anchor object 208 can become bigger to accommodate the larger number of avatars, and/or the avatars can be moved further from anchor object 208 to accommodate the larger number of avatars in front of anchor object 208.

In configuration 206, avatars can be positioned as a crowd around anchor object 208. In example 220A in which only a few avatars (including, e.g., avatar 214A) are around anchor object 208, the avatars can each be positioned at equidistant locations around anchor object 208, such as in pie slice configuration 202. However, as the number of avatars (including, e.g., avatar 214B) increases, the avatars can be staggered around anchor object 208 such that some avatars are standing behind others and have varying distances from anchor object 208. Crowd configuration 206 can be differentiated from boardroom configuration 204, in that anchor object 208 is not made larger to accommodate the larger number of avatars, and/or the avatars are not positioned with equidistance from anchor object 208.

In configuration 222, avatars can be positioned in an arc relative to anchor object 208. In example 224, the avatars (including, e.g., avatar 226) can be positioned on one side of anchor object 208 facing the opposing side of anchor object 208, in which no avatars are positioned. Thus, configuration 222 can be used for a theater-type XR experience, in which a virtual object (e.g., panel 228) can be seen by all of the users accessing the XR experience (e.g., the users corresponding to the avatars including avatar 226). Further details regarding avatar configurations and placement in an XR environment are described in U.S. patent application Ser. No. 18/473,648, filed Sep. 25, 2023, entitled, “Augmented Call Spawn Configuration for Digital Human Representations in an Artificial Reality Environment” (Attorney Docket No. 3589-0267US01), which is herein incorporated by reference in its entirety.

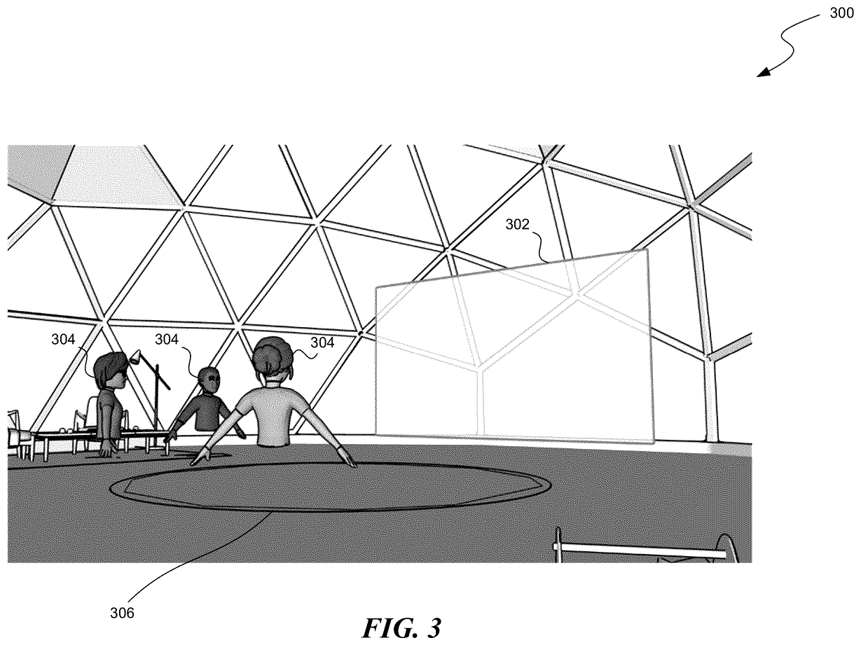

FIG. 3 is a conceptual diagram of a shared XR environment with a theater configuration in which a panel 302 can be shared among multiple users 304. Environment 300 can include panel 302 (e.g., a theater object, such as a virtual media screen) and users 304. Each of users 304 can be displayed a three-dimensional XR environment, by respective XR systems, that can comprise panel 302. For example, a video can be cast to panel 302, and the video can be simultaneously displayed to users 304 via their respective XR systems. Because users 304 are in a theater configuration relative to anchor object 306, as opposed to a configuration encircling anchor object 306, panel 302 can be viewed by all users 304 accessing the XR environment in the direction that their avatars are facing.

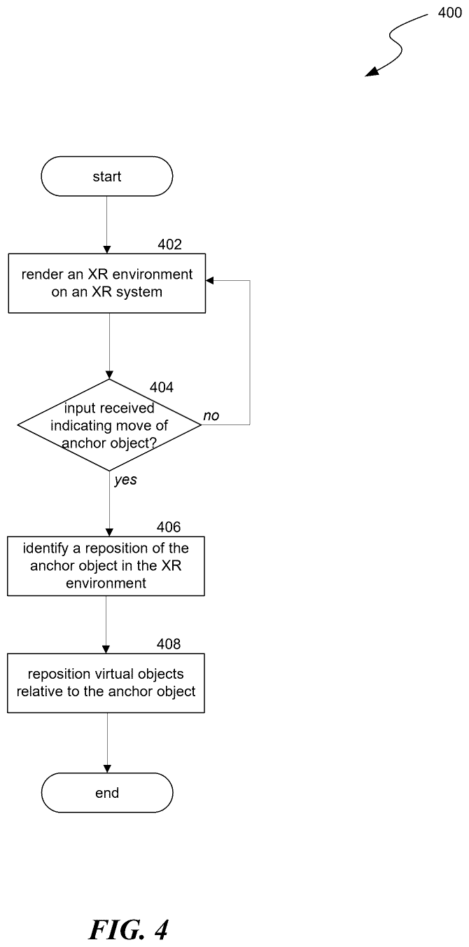

FIG. 4 is a flow diagram illustrating a process 400 used in some implementations for providing a common coordinate system for a multiuser extended reality (XR) environment by anchoring virtual objects to an anchor object. In some implementations, process 400 can be performed automatically as a response to activation or donning of an XR system. In some implementations, process 400 can be performed upon launch of one or more XR applications controlling the XR environment. In some implementations, process 400 can be performed by an XR system including one or more XR systems, such as an XR head-mounted display (HMD), one or more controllers or other input devices, one or more external processing components, etc. In some implementations, one or more steps of process 400 can be performed or facilitated by a remote computing system, such as a platform computing system, edge computing system, cloud computing system, etc.

At block 402, process 400 can render a multiuser XR environment on an XR system. One or more other XR systems can also render the multiuser XR environment. The XR environment can include one or more virtual objects rendered relative to an anchor object. The XR environment can be rendered from a perspective of the user of the XR system (i.e., a user wearing an XR HMD). In some implementations, the user can have a corresponding avatar in the XR environment viewable on other XR systems accessing the XR environment. In some implementations, the one or more virtual objects can include one or more avatars corresponding to other users accessing the XR environment via the other XR systems.

In some implementations, the anchor object can be a virtual object rendered on the XR system and moveable in the XR environment. In some implementations, the anchor object can be static, e.g., having no animated features and/or having no functions other than moveability and display in the XR environment. In some implementations, the anchor object can be dynamic, e.g., having one or more animated features and/or having one or more functions other than moveability and display in the XR environment, such as an interactive menu allowing launch of XR applications and/or functions.

In some implementations, process 400 can intelligently select an origin point for the virtual anchor object for each user within their real-world space. The origin point can be selected based on constraints and/or features defined by, for example, characteristics of the users' physical spaces (e.g., size, layout, furniture, open space, etc.), existing avatars already in the XR environment and their location relative to their existing origin points, requirements of virtual objects (e.g., must be rendered on a wall or tabletop), etc. In some cases, process 400 can construct a model matching portions of the users' spaces, and select respective origin points based on locations within the matched area that meet the defined constraints or other requirements. Further details regarding selecting a location for a virtual anchor object in users' real-world spaces are described in U.S. patent application Ser. No. 19/092,467, filed Mar. 27, 2025, entitled “Shared Coordinate System for Extra Reality Copresence” (Attorney Docket No. 3589-0469US01), which is herein incorporated by reference in its entirety.

In some implementations, the anchor object can be a physical object in a real-world environment around the XR system and viewable while using the XR system. In some implementations, the anchor object can be a “stage device.” As used herein, a “stage device” can be a device separate from an XR HMD, but included in the XR system along with the XR HMD, and can be in operable communication with the XR HMD. The stage device can be, for example, a device obtaining and transmitting its pose and/or position to the XR system, such that virtual objects can be rendered relative to the stage device, as described further herein. In some implementations, the anchor object can be another physical object without electronic and/or communication capabilities with the XR system, whose pose and/or position can be tracked by the XR system using, e.g., computer vision techniques.

In some implementations, the anchor object can act as a moveable spatial anchor for the XR environment. Spatial anchors are world-locked frames of reference that can be created at particular positions and orientations to position content at consistent points in an XR experience, and can be created manually by a user or automatically by the XR system. Conventionally, spatial anchors can be persistent across different sessions of an XR experience, such that a user can stop and resume an XR experience, while still maintaining content at the same locations in the real-world environment relative to the spatial anchors. The anchor object, however, can be moveable, and thus can cause corresponding movement of virtual objects while executing an XR experience or when resuming an XR experience, as described further herein.

In some implementations, process 400 can render a fully immersive, computer-generated virtual reality (VR) experience relative to the anchor object. In some implementations, process 400 can render the VR experience with respect to the anchor object. In some implementations, process 400 can render one or more virtual objects overlaid onto a view of the real-world environment surrounding the XR system, at positions in the real-world environment relative to the anchor object, such as in a mixed reality (MR) or augmented reality (AR) experience. Relative to multiuser XR experiences, it is contemplated that multiple XR systems can access the XR environment from the same or different real-world environments. In the case of MR or AR experiences, it is contemplated that multiple XR systems can view the same virtual objects of an XR environment overlaid onto a view of different real-world environments, when accessing the XR environment from different real-world environments.

At block 404, process 400 can receive input indicating a move for the anchor object in the XR environment. In some implementations, when the anchor object is a stage device in the real-world environment, the input can be movement data, updated position data, and/or updated pose data captured by one or more sensors of the stage device (e.g., one or more sensors of an IMU). In some implementations, when the anchor object is another physical object in the real-world environment, the input can be captured movement data, updated position data, and/or updated pose data for the physical object captured by one or more cameras of the XR system.

In some implementations, when the anchor object is a virtual object, process 400 can receive input associated with or indicative of interaction with the anchor object from an input device, such as one or more handheld controllers that allow the user to interact with the view of the anchor object presented by an XR system. The controllers can include various buttons and/or joysticks that a user can actuate to provide selection input and interact with the anchor object, such as by casting a ray into the XR environment controllable to select the anchor object, then moveable to move the anchor object.

In some implementations, when the anchor object is a virtual object, the input can be a gesture, by the user of the XR system, relative to the anchor object, as detected by the XR system, such as a pinch gesture on or within a threshold distance of the anchor object and a drag motion to a new location. Although described herein with particular exemplary gestures, it is contemplated that process 400 can identify any suitable gesture that can be associated with or indicative of an intention to interact with the anchor object. For example, process 400 can identify a pinch gesture, a tap gesture, a pointing gesture, a circling gesture, an underlining gesture, a movement in a particular direction, etc.

In some implementations, process 400 can detect the gesture via one or more cameras integral with or in operable communication with the XR system, such as cameras positioned on an XR HMD pointed away from the user's face. For example, process 400 can capture one or more images of the user's hand and/or fingers in front of the XR system while making a particular gesture. Process 400 can perform object recognition on the captured image(s) to identify a user's hand and/or fingers making a particular gesture (e.g., pointing, snapping, tapping, pinching, etc.). In some implementations, process 400 can use a machine learning model to identify the motion indicative of a gesture from the image(s). For example, process 400 can train a machine learning model with images capturing known gestures, such as images showing a user's hand making a fist, a user's finger pointing, a user making a sign with her fingers, a user placing her pointer finger and thumb together, etc. Process 400 can identify relevant features in the images, such as edges, curves, and/or colors indicative of fingers, a hand, etc., making a particular gesture. Process 400 can train a machine learning model using these relevant features of known gestures. Once the model is trained with sufficient data, process 400 can use the trained model to identify relevant features in newly captured image(s) and compare them to the features of known gestures. In some implementations, process 400 can use the trained model to assign a match score to the newly captured image(s), e.g., 80%. If the match score is above a threshold, e.g., 20%, process 400 can classify the motion captured by the image(s) as being indicative of a particular gesture. In some implementations, process 400 can further receive feedback from the user regarding whether the identification of the gesture was correct (e.g., by the user re-making the gesture, by the user returning the anchor object to its original location, or by the user leaving the anchor object at its new location), and update the trained model accordingly.

In some implementations, process 400 can determine or confirm a gesture by analyzing a waveform indicative of electrical activity of one or more muscles of the user using one or more wearable electromyography (EMG) sensors, such as on an EMG wristband in operable communication with the XR system. In some implementations, the EMG sensors can capture one or more motions indicative of one or more predefined gestures. For example, the one or more motions can include movement of a hand, movement of one or more fingers, etc., when at least one of the one or more EMG sensors is located on the hand and/or one or more fingers. Process 400 can analyze the waveform captured by one or more EMG sensors worn by the user by, for example, identifying features within the waveform and generating a signal vector indicative of the features. In some implementations, process 400 can compare the signal vector to known gesture vectors stored in a database to identify if any of the known gesture vectors matches the signal vector within a threshold, e.g., is within a threshold distance of a known threshold vector (e.g., the signal vector and a known gesture vector have an angle therebetween that is lower than a threshold angle). If a known gesture vector matches the signal vector within a threshold, process 400 can determine the gesture associated with the vector, e.g., from a look-up table.

In some implementations, process 400 can determine or confirm a gesture based on motion data collected from one or more sensors of an inertial measurement unit (IMU), integral with or in operable communication with the XR system (e.g., in a wearable device in communication with the XR system), to identify and/or confirm the one or more motions of the user. The measurements may include the non-gravitational acceleration of the device in the x, y, and z directions; the gravitational acceleration of the device in the x, y, and z directions; the yaw, roll, and pitch of the device; the derivatives of these measurements; the gravity difference angle of the device; and the difference in normed gravitational acceleration of the device. In some implementations, the movements of the device may be measured in intervals, e.g., over a period of 4 seconds.

For example, when motion data is captured by a gyroscope and/or accelerometer in an IMU of a controller, process 400 can analyze the motion data to identify features or patterns indicative of a particular gesture, as trained by a machine learning model. For example, process 400 can classify motion data captured by a controller or wearable device as a pinching motion based on characteristics of the device movements. Exemplary characteristics include changes in angle of the controller with respect to gravity, changes in acceleration of the controller, etc.

Alternatively or additionally, process 400 can classify the device movements as particular gestures based on a comparison of the device movements to stored movements that are known or confirmed to be associated with particular gestures. For example, process 400 can train a machine learning model with accelerometer and/or gyroscope data representative of known gestures, such as pointing, snapping, waving, pinching, tapping, holding up a certain number of fingers, clenching a fist, spreading the fingers, clicking, tapping, etc. Process 400 can identify relevant features in the data, such as a change in angle of a controller or wearable device within a particular range, separately or in conjunction with movement of the controller or wearable device within a particular range. When new input data is received, i.e., new motion data, process 400 can extract the relevant features from the new accelerometer and/or gyroscope data and compare it to the identified features of the known gestures of the trained model. In some implementations, process 400 can use the trained model to assign a match score to the new motion data, and classify the new motion data as indicative of a particular gesture if the match score is above a threshold, e.g., 25%. In some implementations, process 400 can further receive feedback from the user regarding whether an identified gesture is correct to further train the model used to classify motion data as indicative of particular gestures.

In some implementations, the input indicating a move for the anchor object in the XR environment can alternatively or additionally include user gaze input. In some implementations, process 400 can track the user gaze input via one or more cameras integral with or in operable communication with the XR system, such as cameras positioned on an XR system pointed toward the user's face. For example, process 400 can apply a light source directed to the user's eye which causes multiple reflections around the cornea that can be captured by a camera also directed at the eye. Images from the camera can be used by a machine learning model to estimate an eye position within the user's head. In some implementations, process 400 can also track the position of the user's head, e.g., using cameras that track the relative position of an XR system with respect to the world, and/or one or more sensors of an inertial measurement unit (IMU) in an XR HMD, such as a gyroscope and/or compass. Process 400 can then model and map the eye position and head position of the user relative to the world to determine a vector representing the user's gaze through the XR HMD.

In some implementations, process 400 can detect a gaze dwell (e.g., a dwell selection) at a particular location (e.g., at an anchor object) for a predetermined period of time. For example, based on the user gaze input, the XR system can determine an eye gaze orientation that focuses or maintains a stationary terminus for a duration of time. For example, a user may focus her eye gaze at the anchor object. This pause and focus of gaze can act as a selection of the anchor object, which can then be moved by moving the gaze to a new location, and/or by making a gesture as described herein. Accordingly, in some implementations, process 400 can compare a length (e.g., duration) of the detected dwell to a time threshold.

A “machine learning model,” as used herein, refers to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include: neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the machine learning model can be a neural network with multiple input nodes that receive data about user gesture input and/or user gaze input. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, (“the output layer,) one or more nodes can produce a value classifying the input that, once the model is trained, can be interpreted as wave properties. In some implementations, such neural networks, known as deep neural networks, can have multiple layers of intermediate nodes with different configurations, can be a combination of models that receive different parts of the input and/or input from other parts of the deep neural network, or are convolutions or recurrent—partially using output from previous iterations of applying the model as further input to produce results for the current input.

A machine learning model can be trained with supervised learning, where the training data includes body member data (e.g., hand gesture data, eye gaze data, etc.) as input and a desired output, such as body member states. A representation of hand gesture input and/or gaze input can be provided to the model. Output from the model can be compared to the desired output for that hand gesture input and/or gaze input and, based on the comparison, the model can be modified, such as by changing weights between nodes of the neural network or parameters of the functions used at each node in the neural network (e.g., applying a loss function). After applying each of the hand gesture input and/or user gaze input in the training data and modifying the model in this manner, the model can be trained to evaluate new body member data. Similar training procedures can be used for the various machine learning models discussed above.

In some implementations, the input indicating a move for the anchor object can be an audible announcement by the user to move the anchor object to a new location in the XR environment identifiable by the XR system. The audible announcement can be captured by one or more microphones integral with or in operable communication with the XR system, then can be transcribed, parsed, and/or transformed into a command usable by the XR system. For example, the user can audibly request that the anchor object be moved by a particular distance (e.g., left 1 meter). In another example, the user can audibly request that the anchor object be moved relative to another virtual object (e.g., move the anchor object next to the virtual flower vase).

In still another example, the user can audibly request that the anchor object be moved relative to a physical object in the real-world environment (e.g., on a real-world table, on a real-world couch, etc.). In some implementations, process 400 can identify the stated physical object by applying computer vision, machine learning, and/or object recognition techniques. In some implementations, process 400 can identify the stated physical object from scene data previously established for the real-world environment. For example, the XR system can scan the real-world environment to specify object locations and types within a defined scene lexicon (e.g., desk, chair, wall, floor, ceiling, doorway, etc.). This scene identification can be performed, e.g., through a user manually identifying a location with a corresponding object type or with a camera to capture images of physical objects in the scene and use computer vision techniques to identify the physical objects as object types. In some implementations, the XR system can store the object types in relation to one or more spatial anchors defined for that area, and/or in relation to other localization data, such as mesh data, an XR space model, etc., as described further below.

At block 406, process 400 can, based on the received input, identify a reposition of the anchor object in the XR environment. In some implementations, the reposition of the anchor object can be in six degrees of freedom, sometimes only in one plane—e.g., horizontally to the ground, sometimes only rotationally in one or more planes, or combinations thereof. When the input is physical movement of a stage device, process 400 can identify the reposition of the anchor object based on sensor data captured by the stage device and transmitted to the XR system. When the input is physical movement of another physical object, process 400 can identify the reposition of the anchor object based on movement captured in one or more images by the XR system. Process 400 can analyze such images to determine an amount and direction of movement relative to one or more previously captured images of the anchor object.

When the input is a gesture, process 400 can determine a location at which the gesture is released, a location at which the gesture is terminated (e.g., the gesture lingers at a location for a threshold amount of time, the gesture stops movement, etc.), and/or the location that another gesture, associated with marking a location, is made. In another example, when the input is a gaze, process 400 can determine a location at which the gaze stops moving and dwells at a new location for a threshold amount of time. In still another example, when the input is a controller selection and movement, process 400 can determine a location at which a physical button is released or is reselected. When the input is an audible request by the user, process 400 can determine a new location for the anchor object as designated or specified by the request, and as described above.

In some implementations, in identifying the reposition of a virtual anchor object, process 400 can “snap” the anchor object to a physical object in the real-world environment, such as a table, a wall, a floor, etc., when the requested position of the anchor object is proximate to (i.e., within a threshold distance of) the physical object. In some implementations, process 400 can identify a physical object within the threshold distance of the requested position via scene data specifying object types and locations, as described further above, and reposition the anchor object overlaid onto or positioned proximate to (e.g., on top of, on a side of, on the bottom of) the physical object.

In some implementations, process 400 can “snap” the anchor object to a proximate portion of an XR space model (referred to in some cases as a “room box”) established for the real-world environment, which, in some implementations, can further include scene data. An XR space model (referred to interchangeably herein as a “room box”) can indicate where the walls, floor, and ceiling exist the real-world space. In some implementations, process 400 can obtain the XR space model automatically. For example, a user of an XR system can scan the real-world space using one or more cameras and/or one or more depth sensors by moving and/or looking around the real-world space with the XR system, and automatically identify one or more flat surfaces (e.g., walls, floor ceiling) in the real-world space using such image and/or depth data. For example, process 400 can identify the flat surfaces by analyzing the image and/or depth data for large areas of the same color, of consistently increasing and/or decreasing depth relative to the XR system, and/or of particular orientations (e.g., above, below, or around the XR system), etc. Further details regarding generating and using XR space models are described in U.S. patent application Ser. No. 18/346,379, filed Jul. 3, 2023, entitled “Artificial Reality Room Capture Realignment” (Attorney Docket No. 3589-0262US01), which is herein incorporated by reference in its entirety.

In some implementations, process 400 can “snap” the anchor object to a proximate portion of a mesh established for the real-world environment that was generated by scanning the real-world environment with the XR system. The mesh can be, for example, a three-dimensional (3D) model of the boundaries of the real-world space, including one or more walls, the ceiling, the floor, one or more physical objects, etc. In some implementations, process 400 can generate the mesh using one or more cameras, one or more depth sensors, or any combination thereof. Further details regarding generating and using XR space models and meshes are described in U.S. patent application Ser. No. 18/454,349, filed Aug. 23, 2023, entitled “Assisted Scene Capture for an Artificial Reality Environment” (Attorney Docket No. 3589-0286US01), which is herein incorporated by reference in its entirety. Similarly, in some implementations, process 400 can “snap” the anchor object to a virtual object proximate to (i.e., within a threshold distance of) the requested location of the anchor object in the XR environment, with the virtual object's location known to the XR system.

Reposition of the anchor object in the XR environment can cause corresponding repositioning of the one or more virtual objects relative to the anchor object on the XR system at block 408, such that relational positioning between the anchor object and the one or more virtual objects is maintained. The one or more other XR systems accessing the XR environment can also reposition the one or more virtual objects relative to the anchor object, such that relational positioning between the anchor object and the one or more virtual objects is maintained. The anchor object can be moveable in one or more of any directions, including in an x-axis direction, y-axis direction, z-axis direction, and/or rotationally. For example, process 400 can determine an amount of orientation and/or position change of the anchor object, and reposition the virtual objects with a corresponding amount of orientation and/or position change. For example, if the anchor object is rotated to the left 45 degrees, process 400 can rotate the virtual objects to the left 45 degrees correspondingly. In another example, if the anchor object is moved 1 meter to the right, process 400 can shift the virtual objects 1 meter to the right correspondingly. Thus, the anchor object and the virtual objects maintain their relative orientations and positions, including their separation distances.

Process 400 can cause corresponding repositioning of other avatar(s) accessing the XR environment relative to the anchor object, as rendered on the user's XR system, such that relational positioning between the anchor object and the other avatar(s) is maintained. However, based on the received input identifying the reposition of the anchor object in the XR environment by the user's XR system, the other XR system(s) accessing the XR environment can render the avatar of the user moving reciprocally relative to the anchor object, and, in some implementations, without rendering movement of the anchor object. In other words, as rendered on the other XR system(s), relational positioning of the user's avatar and the anchor object is changed, while relational positioning between the other avatar(s) and the anchor object is maintained, as rendered on their respective XR system(s).

In this sense, the virtual objects can be considered “locked” to the anchor object in the XR environment, as opposed to being “head-locked” (i.e., tied to movement of the head of the user) or “world-locked” (i.e., locked to the real-world environment, regardless of movement of the XR system). In some implementations, however, it is contemplated that some virtual objects may be locked to the anchor object, while others can be head-locked and/or world-locked, as specified by the user, by the XR system, and/or by an XR application executing on the XR system and managing one or more virtual objects rendered in the XR environment.

Thus, according to some implementations provided herein, process 400 can provide continuity and consistency for multiple users accessing an XR environment. By moving virtual objects along with the anchor object as rendered on a user's XR system, and correspondingly moving the user's avatar in the XR environment (and, in some implementations, without movement of the anchor object) as rendered on other users'XR system, some implementations provide for consistent mapping of objects in three-dimensional space. For example, the user can point to a virtual object as rendered on the user's XR system, and other users will see the user pointing at the same virtual object, despite the user's movement of the anchor object. Further, by allowing movement of the anchor object (and corresponding movement of virtual objects), the user experience is improved by allowing users to move the anchor object to reach and interact with virtual objects otherwise out of reach. Further details regarding manipulating an XR environment by anchoring virtual object to an anchor object in the XR environment are described in U.S. patent application Ser. No. 18/634,825, filed Apr. 25, 2024, entitled, “Anchor Objects for Artificial Reality Environments” (Attorney Docket No. 3589-0436US01), which is herein incorporated by reference in its entirety.

In addition, by using the anchor object in the XR environment as a frame of reference, a common coordinate system can be established for multiple different real-world environments. For example, in some implementations, a user can move a virtual object in the XR environment without moving the anchor object. Process 400 can identify a reposition of the virtual object relative to the anchor object in the XR environment, and render the reposition of the virtual object on the XR system. The other XR system(s) accessing the XR environment can similarly render the reposition of the virtual object relative to the anchor object, such that relational positioning between the virtual object and the anchor object is the same on both the XR system and the other XR system(s) (e.g., the distance between the virtual object and the anchor object is the same on all XR system(s) accessing the multiuser XR environment). In this sense, the anchor object can act as an origin point relative to which avatars and virtual objects can be consistently positioned, moved, and/or manipulated on all of the accessing XR systems.

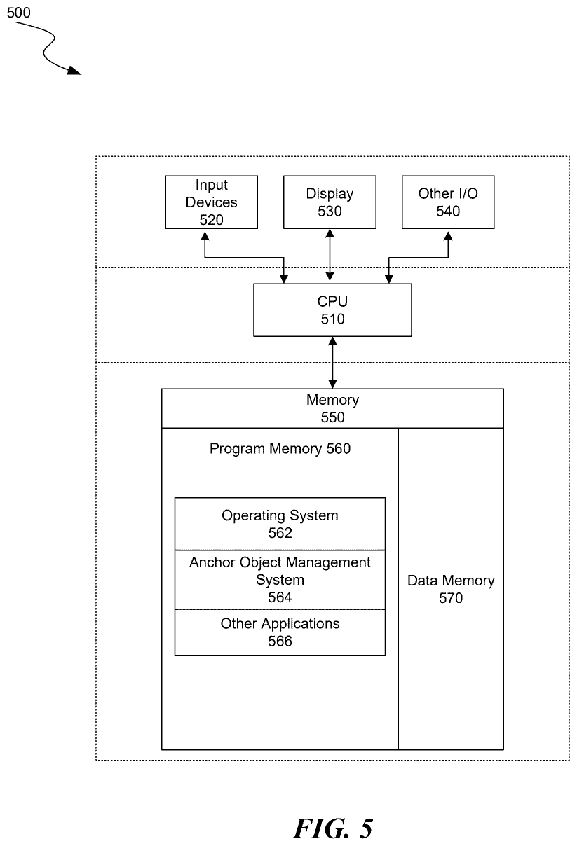

FIG. 5 is a block diagram illustrating an overview of devices on which some implementations of the disclosed technology can operate. The devices can comprise hardware components of a device 500 that can provide a common coordinate system for a multiuser XR environment via an anchor object. Device 500 can include one or more input devices 520 that provide input to the Processor(s) 510 (e.g., CPU(s), GPU(s), HPU(s), etc.), notifying it of actions. The actions can be mediated by a hardware controller that interprets the signals received from the input device and communicates the information to the processors 510 using a communication protocol. Input devices 520 include, for example, a mouse, a keyboard, a touchscreen, an infrared sensor, a touchpad, a wearable input device, a camera-or image-based input device, a microphone, or other user input devices.

Processors 510 can be a single processing unit or multiple processing units in a device or distributed across multiple devices. Processors 510 can be coupled to other hardware devices, for example, with the use of a bus, such as a PCI bus or SCSI bus. The processors 510 can communicate with a hardware controller for devices, such as for a display 530. Display 530 can be used to display text and graphics. In some implementations, display 530 provides graphical and textual visual feedback to a user. In some implementations, display 530 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 540 can also be coupled to the processor, such as a network card, video card, audio card, USB, firewire or other external device, camera, printer, speakers, CD-ROM drive, DVD drive, disk drive, or Blu-Ray device.

In some implementations, the device 500 also includes a communication device capable of communicating wirelessly or wire-based with a network node. The communication device can communicate with another device or a server through a network using, for example, TCP/IP protocols. Device 500 can utilize the communication device to distribute operations across multiple network devices.

The processors 510 can have access to a memory 550 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 550 can include program memory 560 that stores programs and software, such as an operating system 562, anchor object management system 564, and other application programs 566. Memory 550 can also include data memory 570, e.g., anchor object data, rendering data, virtual object data, input data, repositioning data, configuration data, settings, user options or preferences, etc., which can be provided to the program memory 560 or any element of the device 500.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

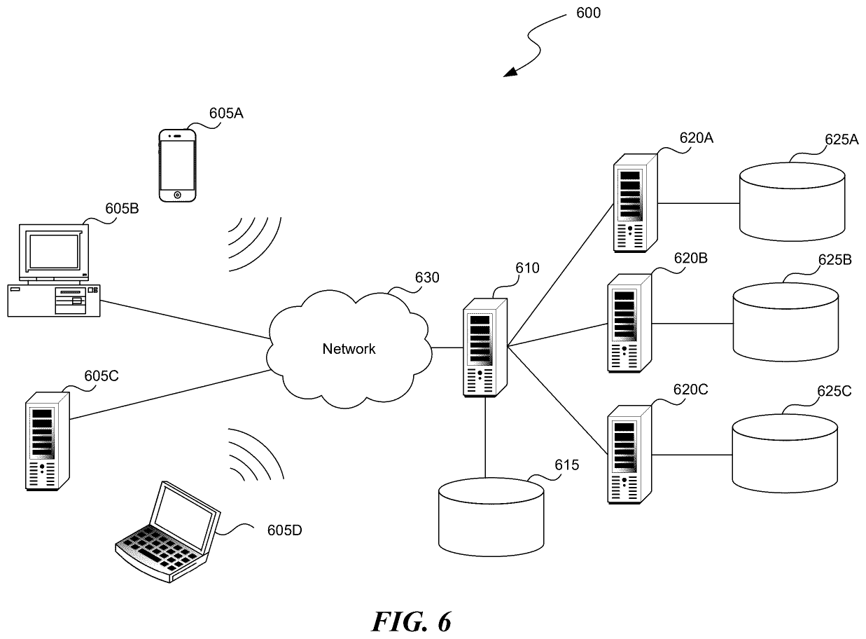

FIG. 6 is a block diagram illustrating an overview of an environment 600 in which some implementations of the disclosed technology can operate. Environment 600 can include one or more client computing devices 605A-D, examples of which can include device 500. Client computing devices 605 can operate in a networked environment using logical connections through network 630 to one or more remote computers, such as a server computing device.

In some implementations, server 610 can be an edge server which receives client requests and coordinates fulfillment of those requests through other servers, such as servers 620A-C. Server computing devices 610 and 620 can comprise computing systems, such as device 500. Though each server computing device 610 and 620 is displayed logically as a single server, server computing devices can each be a distributed computing environment encompassing multiple computing devices located at the same or at geographically disparate physical locations. In some implementations, each server 620 corresponds to a group of servers.

Client computing devices 605 and server computing devices 610 and 620 can each act as a server or client to other server/client devices. Server 610 can connect to a database 615. Servers 620A-C can each connect to a corresponding database 625A-C. As discussed above, each server 620 can correspond to a group of servers, and each of these servers can share a database or can have their own database. Databases 615 and 625 can warehouse (e.g., store) information. Though databases 615 and 625 are displayed logically as single units, databases 615 and 625 can each be a distributed computing environment encompassing multiple computing devices, can be located within their corresponding server, or can be located at the same or at geographically disparate physical locations.

Network 630 can be a local area network (LAN) or a wide area network (WAN), but can also be other wired or wireless networks. Network 630 may be the Internet or some other public or private network. Client computing devices 605 can be connected to network 630 through a network interface, such as by wired or wireless communication. While the connections between server 610 and servers 620 are shown as separate connections, these connections can be any kind of local, wide area, wired, or wireless network, including network 630 or a separate public or private network.

Embodiments of the disclosed technology may include or be implemented in conjunction with an extended reality system. Extended reality, artificial reality, or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021 and now issued as U.S. Pat. No. 11,402,964 on Aug. 2, 2022, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for providing a common coordinate system for a multiuser extended reality environment, the method comprising:
rendering the extended reality environment on an extended reality system,
wherein the extended reality environment includes one or more virtual objects rendered relative to an anchor object, the anchor object being moveable in the extended reality environment, and
wherein the extended reality environment is rendered on one or more other extended reality systems;
receiving input indicating a move for the anchor object in the extended reality environment; and
based on the received input, identifying a reposition of the anchor object in the extended reality environment,
wherein reposition of the anchor object in the extended reality environment causes corresponding repositioning of the one or more virtual objects relative to the anchor object on the extended reality system and the one or more other extended reality systems, such that relational positioning between the anchor object and the one or more virtual objects is maintained.

2. A system as shown and described herein.

3. A computer-readable storage medium storing instructions that, when executed by a computing system, cause the computing system to perform a process as shown and described herein.
